(19) United States
(12) Patent Application Publication
(10) Pub. No.: US 2015/0095330 A1
(43) Pub. Date: Apr. 2, 2015

(54) ENHANCED RECOMMENDER SYSTEM AND METHOD

(71) Applicant: TCL RESEARCH AMERICA INC.

(72) Inventors: LIFAN GUO, Santa Clara, CA (US); HAOHONG WANG, Santa Clara, CA (US)

(73) Assignee: TCL RESEARCH AMERICA INC.

(21) Appl. No.: 14/042,726

(22) Filed: Oct. 1, 2013

(51) Int. Cl. G06F 17/30

(52) U.S. Cl. CPC G06F 17/3053
USPC 707/734; 707/722

(57) ABSTRACT

An enhanced recommender method is provided. The method includes discovering customer features from customer behavior and customer profile and generating an initial recommender list based on the customer features and items information. The method also includes generating item social reputation (ISR) for the customer behavior and the customer profile from an online review repository and generating final recommendation results based on the initial recommender list and the item social reputation.

### FIELD OF THE INVENTION

The present invention relates to the field of computer technologies and, more particularly, to techniques for an enhanced recommender system and method.

### BACKGROUND

Recommender systems have been quite popular in today's commercial and entertainment business. With support of recommenders, a customer spends less time in searching for products that he/she desires. However, the final decision in selecting the one from available options sometimes is time-consuming. Considering an online shopping scenario, influencing customers' decisions on buying their products is even more important in internet marketing since it is directly linked to conversion rate.

A conversion rate means the proportion of visitors to a website who take action beyond a casual content view or website visit. Marketing research has shown that consumer make decisions for several reasons. Knowing the factors which contribute to the buying decision is the key for internet marketing. Generally speaking, it is common that when customers buy an item in real life, the customers consider the price, the appearance of the product, and others' experience of using that product.

Mimicking human shopping behavior in real life, the factors in online shopping also come from metadata and reviews. The metadata comes from products themselves, e.g., price, weight. The reviews come from users experience, such as “the bag has high quality”, “the bag is perfect as a gift”. The metadata which comes from products is naturally used in online shopping, while the reviews which come from user experience cannot easily be utilized due to technical difficulties in natural language understanding.

FIG. 1 shows a typical recommender system. As shown in FIG. 1, at the beginning, certain customer behavior may be built as customer profile, which generates customer features. Then, items information, item candidates, and customer features together are inputted to an item recommender module, leading to an initial recommender list. After filtering and re-ranking, final recommendation results are generated.

However, in such approaches, the user's feedback on items is somewhat superficially processed. For example, online retailers have used reviews in different ways: many sites represent users' sentiments over star ratings. But this approach obviously lacks the factors why the products are given that rating. Some retailers use specific predefined domain-specific aspects for items, such as price, delivery, type and color for a bag. The aspect is a domain specific concept represents topic, with a multinomial distribution over words in the text, e.g., “zipper” in the bag reviews. The topic is a multinomial distribution over words that represent a concept in the text. However, these aspects are static, implying that it could not automatically detect specific and strong reasons that be used to highlight product's features.

Furthermore, there is no further explanation of why one aspect was rated high or low. Besides, other retailers select sentences from high rated reviews as recommendation reasons or let others vote reviews. But it is still impossible for new customers to obtain a whole picture of what reasons people votes. Furthermore, it is obvious that the ubiquitous reasons appears in reviews, such as “price” and “services”, while some specific reasons is invaluable features, such as “water-proof” and “sturdy for windy day”. These issues, namely, centrality and diversity in text summarization community, need to be handled as well in this scenario. Centrality refers to reasons which are similar to many others. The diversity refers to reasons which are distinct to the other. Additionally, it is not feasible to visualize all reasons extracted from reviews to new customers.

The disclosed methods and systems are directed to solve one or more problems set forth above and other problems.

### BRIEF SUMMARY OF THE DISCLOSURE

One aspect of the present disclosure includes an enhanced recommender method. The method includes discovering customer features from customer behavior and customer profile and generating an initial recommender list based on the customer features and items information. The method also includes generating item social reputation (ISR) for the customer behavior and the customer profile from an online review repository and generating final recommendation results based on the initial recommender list and the item social reputation.

Another aspect of the present disclosure includes an enhanced recommender system. The enhanced recommender system includes a customer information extraction module configured to discover customer Item features from customer behavior and customer profile. The enhanced recommender system also includes an item recommender module configured to generate an initial recommender list on the customer features and items information. Further, the enhanced recommender system includes an Item Social Reputation (ISR) module configured to generate item social reputation for the customer behavior and the customer profile from an online review repository. The enhanced recommender system also includes a recommendation generation module configured to generate final recommendation results based on the initial recommender list and the item social reputation.

Other aspects of the present disclosure can be understood by those skilled in the art in light of the description, the claims, and the drawings of the present disclosure.

### BRIEF DESCRIPTION OF THE DRAWINGS

FIG. 1 illustrates an exemplary existing recommender system;

FIG. 2A illustrates an exemplary environment incorporating certain embodiments of the present invention;

FIG. 2B illustrates an exemplary computing system consistent with the disclosed embodiments;

FIG. 3 illustrates an exemplary Item Social Reputation (ISR) enhanced recommender system consistent with the disclosed embodiments;

FIG. 4A illustrates an exemplary work flow of generating ISR consistent with the disclosed embodiments;

FIG. 4B illustrates an exemplary generation of ISR consistent with the disclosed embodiments;

FIG. 5 illustrates an exemplary Aspect and Sentiment Aggregation Model with Term Weighting Schemes (ASAMTWS) consistent with the disclosed embodiments;

FIG. 6 illustrates an exemplary plate notation for smoothed Latent Dirichlet Allocation (LDA) consistent with the disclosed embodiments;

FIG. 7A and FIG. 7B illustrate an exemplary Diversity in Ranking High Quality Aspect (DRHQA) model consistent with the disclosed embodiments;

FIG. 8A illustrates a current recommendation;

FIG. 8B illustrates an exemplary recommendation in an enhanced recommender system with ISR consistent with the disclosed embodiments; and

FIG. 8C illustrates another exemplary recommendation in an enhanced recommender system with ISR consistent with the disclosed embodiments.

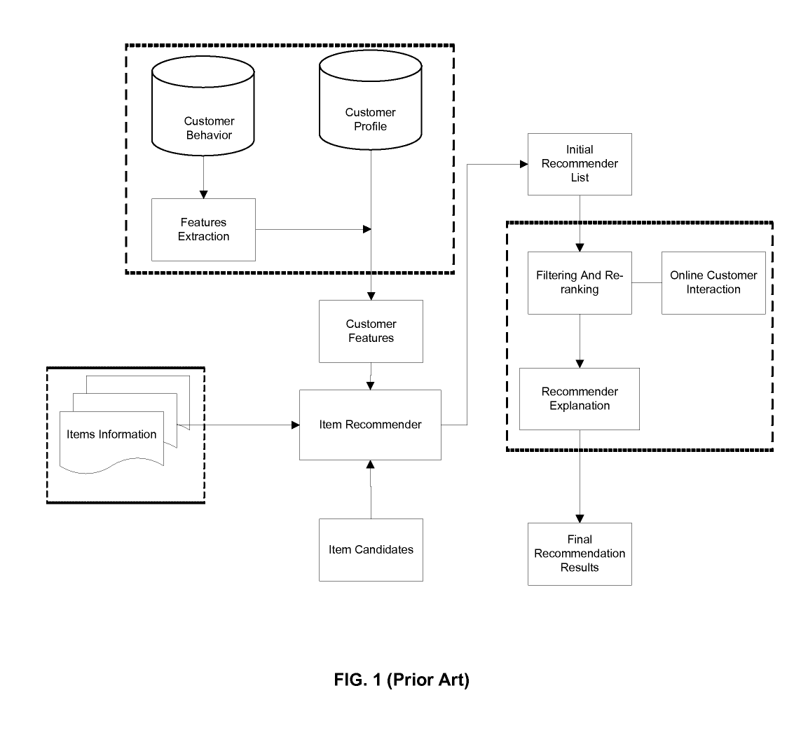

### DETAILED DESCRIPTION

Reference will now be made in detail to exemplary embodiments of the invention, which are illustrated in the accompanying drawings. Wherever possible, the same reference numbers will be used throughout the drawings to refer to the same or like parts.

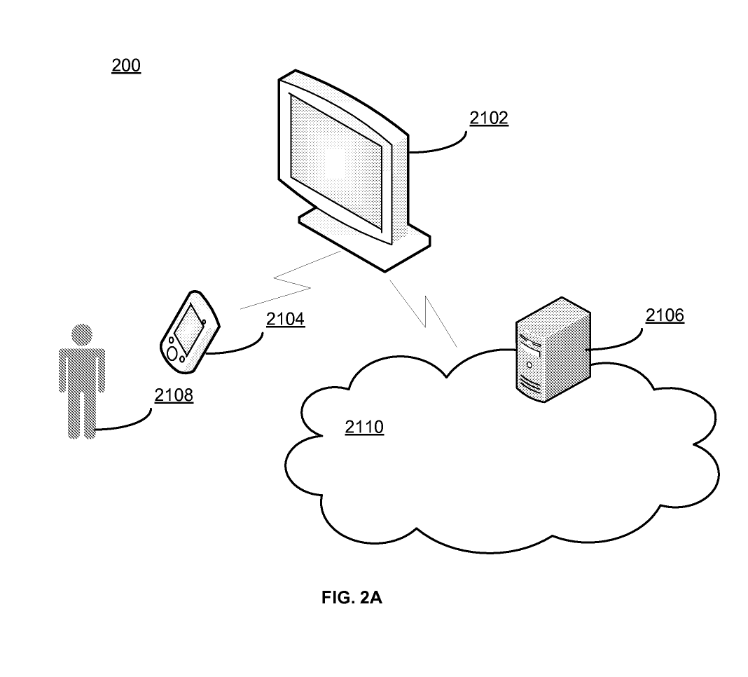

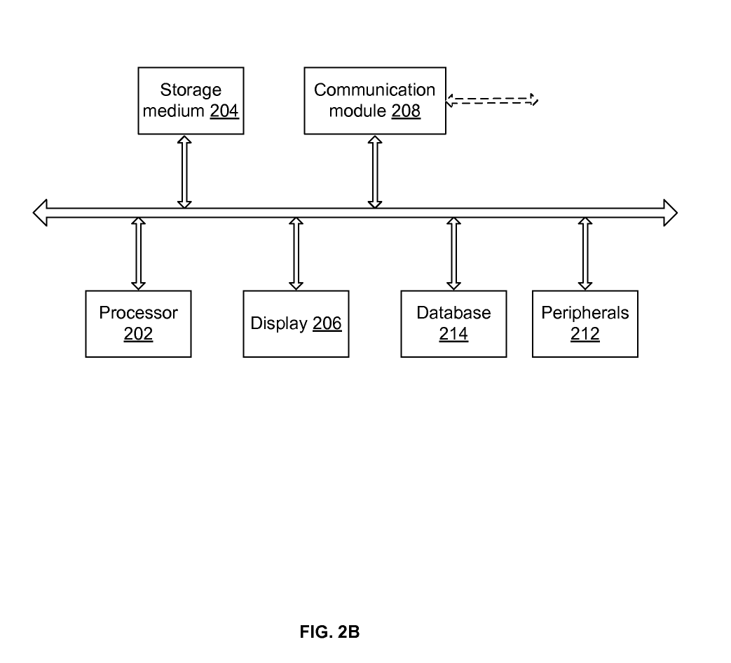

FIG. 2A illustrates an exemplary environment 200 incorporating certain embodiments of the present invention. As shown in FIG. 2A, the environment 200 includes a television set (TV) 2102, a remote control 2104, a server 2106, a user 2108, and a network 2110. Other devices may also be included.

TV 2102 may include any appropriate type of TV, such as plasma TV, LCD TV, projection TV, non-smart TV, or smart TV. TV 2102 may also include other computing system, such as a personal computer (PC), a tablet or mobile computer, or a smart phone, etc. Further, TV 2102 may be any appropriate content-presentation device capable of presenting multiple programs in one or more channels, which may be controlled through remote control 2104.

Remote control 2104 may include any appropriate type of remote control that communicates with and controls the TV 2102, such as a customized TV remote control, a universal remote control, a tablet computer, a smart phone, or any other computing device capable of performing remote control functions. Remote control 2104 may also include other types of devices, such as a motion-sensor based remote control, or a depth-camera enhanced remote control, as well as simple input/output devices such as keyboard, mouse, voice-activated input device, etc.

Further, the server 2106 may include any appropriate type of server computer or a plurality of server computers for providing personalized contents to the user 2108. The server 2106 may also facilitate the communication, data storage, and data processing between the remote control 2104 and the TV 2102. TV 2102, remote control 2104, and server 2106 may communicate with each other through one or more communication networks 2110, such as cable network, phone network, and/or satellite network, etc.

The user 2108 may interact with TV 2102 using remote control 2104 to watch various programs and perform other activities of interest, or the user may simply use hand or body gestures to control TV 2102 if motion sensor or depth-camera is used by TV 2102. The user 2108 may be a single user or a plurality of users, such as family members watching TV programs together.

TV 2102, remote control 2104, and/or server 2106 may be implemented on any appropriate computing circuitry platform. FIG. 2B shows a block diagram of an exemplary computing system capable of implementing TV 2102, remote control 2104, and/or server 2106.

As shown in FIG. 2B, the computing system may include a processor 202, a storage medium 204, a display 206, a communication module 208, a database 214, and peripherals 212. Certain devices may be omitted and other devices may be included.

Processor 202 may include any appropriate processor or processors. Further, processor 202 can include multiple cores for multi-thread or parallel processing. Storage medium 204 may include memory modules, such as ROM, RAM, flash memory modules, and mass storages, such as CD-ROM and hard disk, etc. Storage medium 204 may store computer programs for implementing various processes, when the computer programs are executed by processor 202.

Further, peripherals 212 may include various sensors and other I/O devices, such as keyboard and mouse, and communication module 208 may include certain network interface devices for establishing connections through communication networks. Database 214 may include one or more databases for storing certain data and for performing certain operations on the stored data, such as database searching.

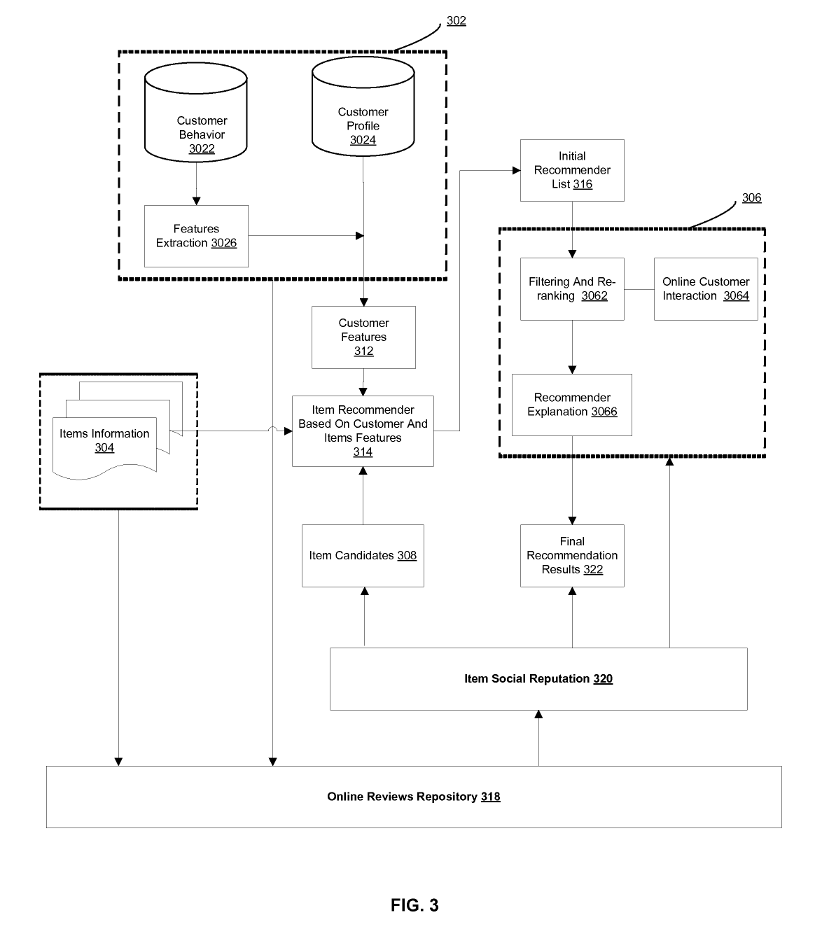

TV 2102, remote control 2104, and/or server 2106 may implement a personalized item recommender system for recommending personalized item to user 108. FIG. 3 illustrates an exemplary enhanced recommender system with the support of Item Social Reputation (ISR).

The ISR enhanced recommender system may analyze the reasons driving previous customers to buy an item from online reviews repository. As shown in FIG. 3, the enhanced recommender system includes a customer information extraction module 302, items information 304, a recommendation generation module 306, item candidates 308, customer features 312, an item recommender module 314, an initial recommender list 316, an online reviews repository 318, an Item Social Reputation (ISR) module 320, and final recommendation results 322. Certain components may be omitted and other components may be added.

The customer information extraction module 302 is configured to discover customer features from customer behavior and customer profile. The customer information extraction module 302 further includes customer behavior 3022, customer profile 3024, and features extraction 3026. The customer behavior 3022 may include any appropriate information, such as transaction history, browse history, frequently accessed websites, etc. The customer profile 3024 may include any appropriate customer information, such as age, region, education level, etc.

The items information 304 includes price, appearance, service and other information. For example, appearance information may include type, color, weight, and size.

The item recommender module 314 is configured to discover items based on customer features and item features and to output recommended items to initial recommender list 316.

The recommendation generation module 306 can be further divided into three submodules: filtering and re-ranking submodule 3062, online customer interaction submodule 3064, and recommender explanation submodule 3066. The online customer interaction submodule 3064 may detect customer behaviors by communicating with the customer's personal device, by face recognition, and/or by remote control usage pattern, etc. Based on information from the filtering and re-ranking submodule 3062, recommender explanation submodule 3066 may generate final recommendation results. That is, once the personalization detection and explanation are done, the recommendation generation module 306 is configured to handle item selection and to generate final recommendation results 322 for the user 108.

A list of items are revised and re-ranked by the filtering and re-ranking submodule 3062 and the online customer interaction submodule 3064, without representing the factors that drive previous users to buy an item, which can be used as strong reasons for new customers to make a buying decision. The reasons refer to positive aspect with high aspect quality. The aspect quality refers to ability of top ranked words grouped by aspect to provide coherent and consistent meaning. It is very helpful if an item has a well-established reputation which can be used by the new customer as a reference.

Further, reviews may contain different sentiments about aspect. To be selected as buying reasons to new customers, aspects need be paired with sentimental value. It is reasonable that the system recommends positive aspects as reasons to new customers to persuade the new customers make decision. In other words, the aspects may need to be linked to sentiments.

The Item Social Reputation (ISR) module 320 is configured to select top K salient positive aspects extracted from customers' reviews on a specific item. In order to make sure the fairness, the reviews are collected from all related websites instead of from a single store or website and stored in the online reviews repository 318. Each aspect of ISR contains a list of terms that have close semantic meanings to that aspect. Each term has a list of positive reviews as supports for that aspect. ISR is extracted to help provide a better match of customer's preference. Furthermore, ISR can be visualized as features adding on final recommendation results, providing facilities for customers to find their preference. Therefore, the system achieves a desired performance in supporting the customer to achieve his/her goal in terms of improving conversation rate.

Thus, in various embodiments, a recommender system with built-in item social reputation learning mechanism is provided. By incorporating ISR into current recommender system, customers' user experience can be enhanced. More importantly, explicit representing buying reasons of previous customers help current customer to find his/her goal quickly, thus improving the conversation rate.

In operation, an ISR enhanced recommender may perform certain processes to recommend personalized items to a customer. At the beginning, customer information extraction module 302 may discover customer features from customer behavior and customer profile. ISR module 320 may generate item social reputation (ISR) from online review repository. Then, an initial recommender list is generated based on customer and items features. Recommendation generation module 306 handles item selection and generates final recommendation results.

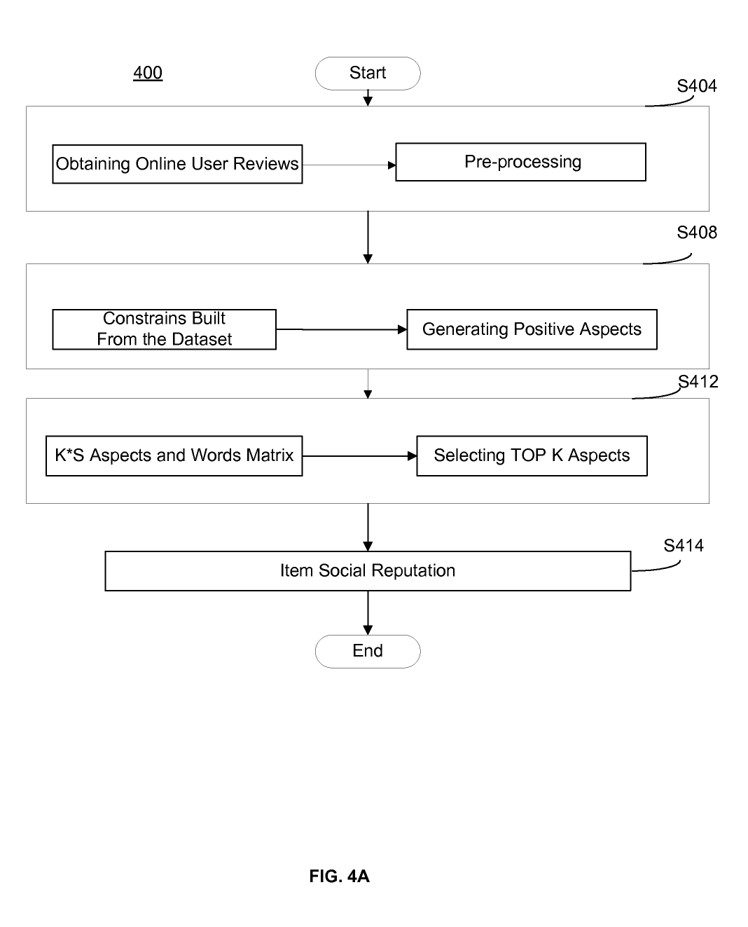

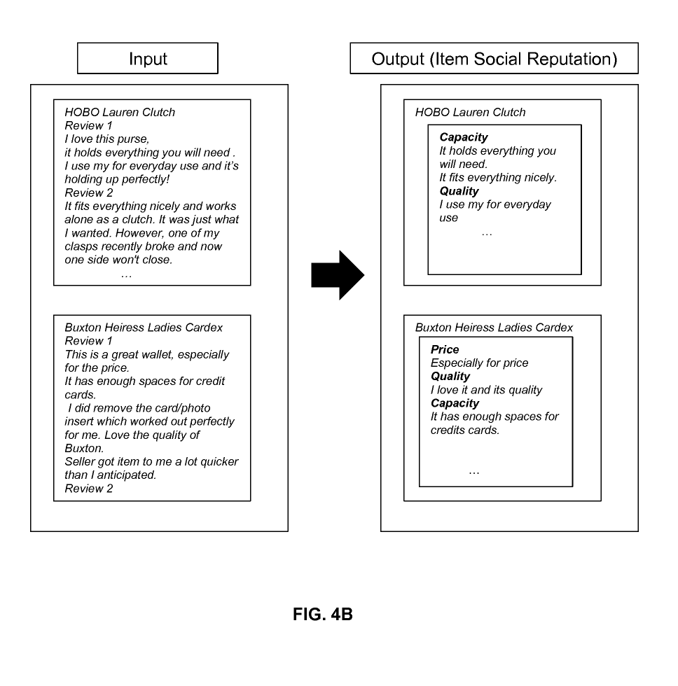

FIG. 4A illustrates an exemplary work flow 400 of generating ISR consistent with the disclosed embodiments. FIG. 4B gives an example of generation process of ISR. The left part of FIG. 4B illustrates inputs of work flow 400 of generating ISR. It includes reviews stored in the online reviews repository. The right part of FIG. 4B illustrates an example of ISR. For an item “HOBO Lauren Clutch”, its ISR are capacity and quality; while for an item “Buxon Heiress Ladies Cardex”, its ISR are price, quality and capacity. Terms “hold”, “space” and “credit cards” are the list of terms in “capacity” in ISR. “It holds everything a user needs” gives supports for capacity. Building ISR and Incorporating ISR into current recommender system help influence customers' buying decisions.

As shown in FIG. 4A, at the beginning, online user reviews may be collected from all related websites instead of from a single store or website and stored in the online reviews repository 318.

Chunks and constrains from pre-existing knowledge are generated in the pre-processing process (S404). In S404, the inputs are reviews stored in the online reviews repository 318, the outputs are chunks and constrains. The chunk refers to a group of words which express fine regional sentimental and semantic meanings. For example, a sentence of “especially with the clasp, but it is so attractive” conveys two latent aspects “price” and “appearance”, respectively. Then, this sentence is divided into two chunks. Therefore, for a given sentence, if there are no transition words and phrases involved, the sentence is used as a chunk. Otherwise, the sentence can be split by transition words and phrases. The transition words and phrases refer to words and phrases used for linking words together. A must-link or cannot-link constrain can be added between each two consecutive chunks if necessary.

The reviews are unstructured data across the websites, and crawler is used to crawl semi-structure reviews from public websites. Each word is assigned a value of parts of speech (POS). The pre-processing includes the following steps:

Step 1: a sentence is split.

Step 2: if the sentence does not contain any defined transition word or phrase, the sentence is used as a chunk; otherwise, the work flow goes to Step 3.

Step 3: the whole sentence is split by the transition words or phrases into two chunks or two sentences. If any sentence has the transition words, the work flow goes to Step 2.

Steps 2 and 3 are repeated until the original sentence is separated into a plurality of chunks and all chunks do not contain any transition word or phrase. Then, the work flow goes to Step 4.

Step 4: if there is the transition word or phrase between two consecutive chunks, either must-link or cannot-link is added; if the transition word or phrase belongs to opposition/limitation/contradiction category, a cannot-link is built; otherwise, a must-link is built; if there is no must-link or cannot-link that can be built, there is no-link between these two chunks.

Further, the online reviews, after the pre-processing is complete, are treated as inputs to Aspect and Sentiment Aggregation Model with Term Weighting Schemes (ASAMTWS).

Let p={p₁, p, . . . , pₘ} be a set of products which comes from “bag” domain. For each product pᵢ, there is a set of reviews r={r₁, r₂, . . . , r_{d}}. For each review rᵢ, there are a set of chunks c={c₁, c₂, . . . , cₗ}, and a non-negative value of the other's voting information of reviews. For each pair of two consecutive chunks, it has constrains including three possible conditions {must-link, cannot-link, no-link}. For each chunk cᵢ, there is a set of words w={w₁, w₂, . . . wₙ}.

After constrains are built from the dataset, positive aspects can be generated from ASAMTWS (S408). A major component in the method is to automatically discover what aspects are evaluated in reviews and how sentiments for different aspects are expressed. Pre-existing knowledge is added as constrains to achieve better results theoretically and practically.

ASAMTWS illustrates the generative process of a review as follows: the customer decides to write review of an item with a distribution of sentiments, say, 60% satisfied and 40% unsatisfied. Then, he/she decides to express the rational by expresses a distribution of aspects, say, 20% service, 60% color, 20% quality. Then he/she decides to write reviews to express which he/she feels that sentiments. If the review is useful to the others, the review gets positive voting.

For every pair of sentiment s and aspect z, a word distribution øₜₛ˜Drichilet (βₛ) is drawn. For each review r, an r's sentiment distribution πᵣ˜Drichilet (γ) is drawn. For each sentiment s, an aspect distribution θᵣₛ˜Dirichilet (α) is drawn based on the sentiments dictionary. For each chunk, a sentiment j˜Multinomial (πᵣ) based on other chunks that has constrains is chosen; given sentiment j, an aspect k˜Multinomial (θᵣₛ) based on other chunks that has constrains is chosen; words w˜Multinomial (Øₜₛ) based on word frequency in the dataset and reviews' voting information is generated.

FIG. 5 illustrates an exemplary ASAMTWS consistent with the disclosed embodiments. As shown in FIG. 5, in the graphical representation of ASAMTWS, nodes are random variables, and edges are dependencies. Plates are replications. Only shaded nodes are observable. The notation used in ASAMTWS is in Table 1.

TABLE 1
Meanings of the Notations

| | | | | | | | |
|---|---|---|---|---|---|---|---|
| R | The number | π | Multinomial distribution | γ | Dirichlet prior of π | s₋ᵢ | Sentiments for |
| | of reviews | | over sentiments | | | | all chunks |
| | | | | | | | except i |
| C | The number | θ | Multinomial distribution | α | Dirichlet prior of θ | z₋ᵢ | Aspects for all |
| | of chunks | | over aspects | | | | chunks except i |
| N | The number | s | Sentiments | β | Dirichlet prior of Ø | w | All words in |
| | of words | | | | | | reviews |
| V | The | z | Aspect | Cᵣⱼ^{RS} | The number of | Dictionary | Sentiment |
| | vocabulary | | | | chunks that assigned | | Dictionary |
| | | | | | sentiment j in review r | | |
| S | The number | Ø | Multinomial distribution | C_{djk}^{RST} | The number of | Constrains | Must-link and |
| | of sentiments | | over aspects | | chunks that assigned | | cannot -link from |
| | | | | | sentiment j and | | |
| | | | | | aspect k | | |
| T | The number | w | word | M_{jkw}^{STW} | The weighting of | m_{lw} | Number of words |
| | of aspects | | | | words that assigned | | in chunk l |
| | | | | | sentiment j and | | |
| | | | | | aspect k | | |

The latent variables in FIG. 5 are inferred by Gibbs Sampling. Gibbs sampling is a Markov chain Monte Carlo algorithm for obtaining a sequence of observations, which are approximated from a specified multivariate probability distribution when direct sampling is difficult. At each transition step of the Markov chain, the sentiment and aspect of the lth chunk are chosen according to the conditional probability:

$$P ( {s}_{i} = j , {z}_{i} = k \vert {s}_{- i} , {z}_{- i} , w ) ∝ q ( {s}_{i} = j ) q ( {z}_{i} = k ) \frac{{C}_{rj}^{RS} + {y}_{j}}{{C}_{rj ( . )}^{RS} + {y}_{j ( . )}} \frac{{C}_{djk}^{RST} + {α}_{k}}{{C}_{djk}^{DST} + {α}_{k ( . )}} \frac{Γ ( {\sum }_{w = 1}^{W} {M}_{jkw}^{STW} + {β}_{jw} )}{Γ ( {\sum }_{w = 1}^{W} ( {M}_{jkw}^{STW} + {β}_{jw} ) + {m}_{l} )} {\prod }_{w = 1}^{W} \frac{Γ ( {M}_{jkw}^{STW} + {β}_{jw} + {m}_{lw} )}{Γ ( {M}_{jkw}^{STW} + {β}_{jw} )} \qquad ( 1 )$$

The approximate probability of sentiment j in review r is defined by:

$${π}_{rj} = \frac{{C}_{rj}^{RS} + {y}_{j}}{{C}_{rj ( . )}^{RS} + {y}_{j ( . )}} \qquad ( 2 )$$

The approximate probability of aspect k for sentiment j in review d is defined by:

$${θ}_{rjk} = \frac{{C}_{djk}^{RST} + {α}_{k}}{{C}_{djk}^{DST} + {α}_{k ( . )}} \qquad ( 3 )$$

The approximate probability of word w is aspect-sentiment k-j (The aspect-sentiment refers to a multinomial distribution over words that express the sentiment of a specific aspect. for example: “sturdy” for “zipper” in the bag reviews.), which is defined by:

$${φ}_{jkw} = \frac{{M}_{jkw}^{STW} + {β}_{jw}}{{\sum }_{w = 1}^{W} ( {M}_{jkw}^{STW} + {β}_{jw} )} \qquad ( 4 )$$

In Equation 1, the middle two terms,

$$\frac{{C}_{rj}^{RS} + {y}_{j}}{{C}_{rj ( . )}^{RS} + {y}_{j ( . )}} \frac{{C}_{djk}^{RST} + {α}_{k}}{{C}_{djk}^{DST} + {α}_{k ( . )}} ,$$

indicate the importance of chunk in sentiment j and aspect k. The last two terms indicate the importance of sentiment j and aspect k in review d. q(sᵢ=j) and q(zᵢ=k)play the role of intervention from pre-existing knowledge of constrains. M_{jkw}^{STW} plays the role of weighting terms based on frequency and reviews' quality.

Specifically, chunk's topic depends on constrains. A topic refers to a multinomial distribution over words that represent a concept in the text. To calculate the probability of the l^{th} chunk topic, for a candidate topic k, if the must-link chunk has a high probability in k, q(zᵢ=k) is used to enhance words probability in k in the l^{th} chunk. If the cannot-link chunk has high probability in k, q(zᵢ=k) is used to decrease words probability in k in the l^{th} chunk. If there is no chunk has links to the current chunk, q(zᵢ=k)=1.

Formally, if there are must-link chunks,

$$q ( {z}_{i} = k ) = Normalized {\sum }_{must \text{-} link chunk ' s topic} \frac{( 1 + Max ( q ( {z}_{n} = k ) ) )}{The number of chunks must \text{-} linked to lth chunk} \qquad ( 5 )$$

If there are cannot-chunks,

$$\begin{matrix}q ( {z}_{i} = k ) = Normalized {\sum }_{must \text{-} link chunk ' s topic} \frac{( 1 - Max ( q ( {z}_{n} = k ) ) )}{The number of chunks must \text{-} linked to lth chunk} & ( 6 ) \\ else , q ( {z}_{i} = k ) = 1 & ( 7 )\end{matrix}$$

Specifically, chunk's sentiment depends on sentiment lexicon and current chunk's must-link and cannot-link chunks' sentiment. The sentiment lexicon assigns the opinioned words with sentimental value as a prior knowledge p(wᵢ), the sentiment distribution. The current chunk's must-link and cannot-link chunks' sentiment have impact on the current chunk. It can be defined by:

$$q ( {s}_{i} = j ) = \frac{p ( {w}_{i} + ɛ ) q ( {s}_{j} = k )}{Normalization Value} \qquad ( 8 )$$

where ε indicates a dump value that controls the influence of dictionary; q (sⱼ=k) indicates the impact from linked chunks' sentiments, which has similar formula with q(zᵢ=k).

M_{jkw}^{STW} is a weighting term based on frequency and reviews' quality, which is defined by:

$${M}_{jkw}^{STW} = - {log}_{2} \frac{Number of the word in review j}{Total number of the word in the dataset} ( \frac{postive voting in review j}{Total voting of the review j} + 1 ) {C}_{jkw}^{STW} \qquad ( 9 )$$

C_{jkw}^{STW} indicates the number of words that are assigned sentiment j and aspect k. The first item is similar to Pointwise Mutual Information (PMI), which has a solid basis in information theory and has been shown to work well in the context of Latent Semantic Indexing (LSI). It is possible for PMI of a term to be negative, such as background words (e.g. ‘bag’, ‘purse’). When this happens, the weighting of that term is assigned to 0. The second item is used to leverage the importance of the reviews. More positive voting a review draw, more weightings added to the words in the review.

Those constrains can also be reduced in some way. These constrains enhanced the popular extensions of other topic modeling methods, with the ability to consider different scenario and be easily extended into different context. The reasons why these constrains could help original topic modeling can be summarized as: (1) ASAMTWS changes original unsupervised topic modeling to semi-supervised; (2) ASAMTWS explores and utilizes shallow semantic meaning of documents to break original topic modeling which has independently and identically distributed (i.i.d.) assumption for both terms and document; (3) ASAMTWS innovatively incorporate social information, voting information of reviews, into tackling aspects and sentiments identification problem.

For the domain of bag, K*S latent aspects and corresponding sentiment groups from M*D reviews need to be identified. Each group is presented by N words ranking by how likely they appear in it. Then, each product has a vector v with the length of K*S. This vector presents that how likely that product has the aspect and corresponding sentiment.

Based on a vector v, top K aspects are selected (S412), as reasons to new customers based on three criteria: (1) Top K aspects have positive sentimental value; (2) Words ranked in each aspect have optimal semantic coherence; (3) Top K aspects balance centrality and diversity. That is, the system automatically discovers top K salient reasons (e.g. capacity) with positive interpretive supports (e.g. it has enough spaces for credits cards).

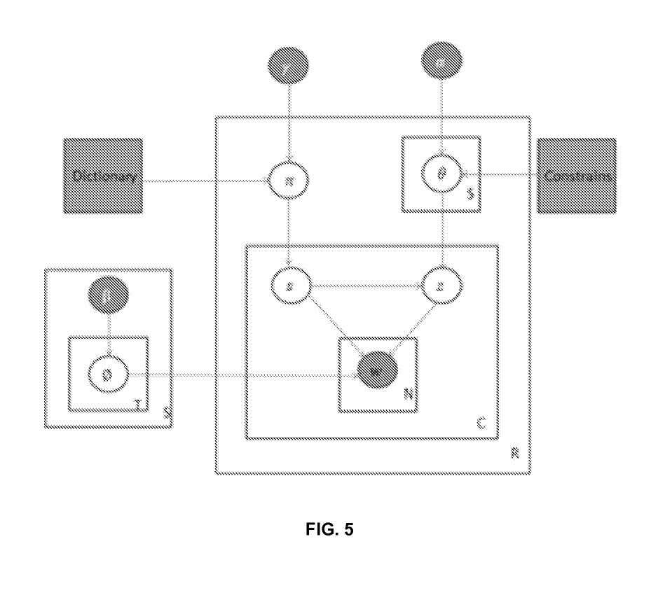

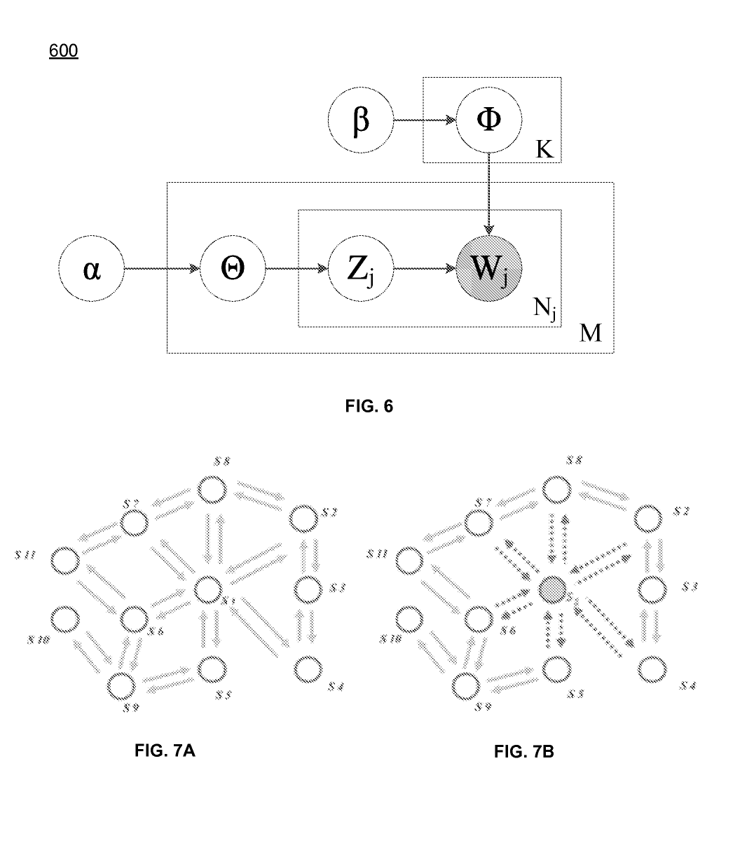

There are two problems being defined for selecting K aspects. First, frequently occurring noun phrases (NP), which present aspects, are discovered for the purpose of using reviews. However, NP detection method depends on pre-defined rules in the system, thus NP detection method lack generality in cross domains and is very time consuming. Second, a topic model, as a suitable method and a graphical model, needs to be created. Specifically, Latent Dirichlet Allocation (LDA) is a representative topic model that may be used to address this problem. FIG. 6 illustrates an exemplary plate notation for smoothed latent dirichlet allocation (LDA) consistent with the disclosed embodiments. LDA represents a document as random mixtures over latent topics, denoted as Z=(z₁, . . . , zₖ, . . . , z_{K}), where K is the total number of topics, and each topic zₖ is characterized by a distribution over words. That is, the LDA algorithm models the M documents in a corpus as mixtures of K topics where each topic is a distribution over W terms. Given θ, the matrix of mixing weights for topics within each document, and Ø, the matrix of weights for words within topics. Therefore, LDA model decomposed original document-word matrix to document-topic matrix and topic-word matrix. Although LDA is used herein as the basic form of these variants, other methods based on LDA may also be used.

The LDA model can be treated as a way to decompose high dimension matrix, with a semantic explanation of results. The LDA model is a domain-free and unsupervised model based on graphical model that is suitable for large data. However, applying the LDA model directly to this problem is not desirable since it assumes: (1) document and document are independently; (2) words are independently and identically distributed; (3) the LDA model needs extension to integrate sentiments information that corresponds to aspects.

As used herein, the ASAMTWS and Diversity in Ranking High Quality Aspect (DRHQA) model together is used to extract top K high quality salient aspects as ISR in the purpose of the enhancing the current recommendation system.

A term-aspect matrix is obtained from ASAMTWS. The length of a row is the size of vocabulary of words in the dataset, and the length of column is K aspects in the dataset. If K is selected too small, topics mix together; otherwise, it takes more efforts for human to find which topics have higher quality in terms of coherent and consistent.

K high quality aspects that have positive sentiments as reasons from k*s aspects can be found by DRHQA model. The input of DRHQA model is a matrix W (positive aspect×terms with probability of that aspect).

GRASSHOPPER algorithm is also a ranking algorithm which ranks items with an emphasis on diversity. The major difference between DRHQA model and GRASSHOPPER algorithm are the calculation for aspect similarity and aspect quality.

The aspect similarity is calculated by using Equation 10 after pre-processing. Since each column represents the word distribution of a certain aspect, KL-divergence is better to estimate the similarity of two aspects:

$$\begin{matrix} sim ( {V}_{i}^{( {t}_{a} )} , {V}_{j}^{( {t}_{b} )} ) = {10}^{IR ( {V}_{i}^{( {t}_{a} )} , {V}_{j}^{( {t}_{b} )} )} & ( 10 ) \\ IR ( {V}_{i}^{( {t}_{a} )} , {V}_{j}^{( {t}_{b} )} ) = KL ( {V}_{i}^{( {t}_{a} )} \vert \vert \frac{{V}_{i}^{( {t}_{a} )} , {V}_{j}^{( {t}_{b} )}}{2} ) + KL ( {V}_{i}^{( {t}_{a} )} \vert \vert \frac{{V}_{i}^{( {t}_{a} )} , {V}_{j}^{( {t}_{b} )}}{2} ) & ( 11 ) \\ KL ( p \vert \vert q ) = {\sum }_{i} {p}_{i} log \frac{{p}_{i}}{{q}_{i}} & ( 12 )\end{matrix}$$

pᵢ and qᵢ≠0; sim (Vᵢ^{(t}^{ₐ}⁾, Vⱼ^{(t}^{_{b}}⁾) is symmetric.

The aspect quality is calculated by Equation 13:

$$C ( t ; {V}^{( t )} ) = {\sum }_{m = 2}^{M} {\sum }_{f = 1}^{m - 1} log \frac{D ( {V}_{m}^{( t )} , {V}_{f}^{( t )} ) + 1}{D ( {V}_{f}^{( t )} )} \qquad ( 13 )$$

where D(v) denotes the review frequency of word type v (i.e., the number of reviews with least one token of type v) and D(v, v′) is co-review frequency of word types v and v′. V^{(t)}=(v₁^{t}, . . . , v_{M}^{t}) is a list of the M most probable words in topic t.

After a qualified aspect is selected, the quality of aspects similar to selected ones is decreased by:

C(t; V^{(t}^{ⱼ}⁾)=(1−ωS(Vᵢ^{(t}^{ᵢ}⁾, Vⱼ^{(t}^{ⱼ}⁾))C(t; V^{(t}^{ⱼ}⁾) (14)

The inputs of the DRHQA model include a matrix W (positive aspect×terms with probability of that aspect), an aspect quality matrix q, dumping values [symbol] ,ω, and a quality threshold ρ. The quality of aspects refers to ability of top ranked words grouped by aspect to provide coherent and consistent meaning.

The DRHQA model is defined as follows:

Step 1: an initial Markov chain P is created from W, q and [symbol] .

Step 2: the operation of computing P's stationary distribution π is repeated, and the first item g₁=argmaxπᵢ is picked. If C(g₁)>ρ, Step 2 is stopped and g₁ is added to results.

Step 3: the operations (a)-(d) is repeated until no more items are needed to be ranked:
(a) Ranked items are turned into absorbing states.
(b) All aspect's quality is updated based on Equation 14.
(c) The expect number of visits v for all remaining items is computed. The next item gₙₑₓₜ=argmaxv is picked.
(d) C(gₙₑₓₜ) is calculated. If C(gₙₑₓₜ)>ρ, gₙₑₓₜ is added to results.

In a DRHQA model, a graph reflecting domain knowledge has n nodes (S₁, S₂, . . . , Sₙ). The graph can be represented by an n×n weight matrix W, where wᵢⱼ is the weight on the edge from i to j. It can be either directed or undirected. W is symmetric for undirected graphs. The weights are non-negative. FIG. 7A and FIG. 7B illustrate a DRHQA model. As shown in FIG. 7A, a graph has 11 nodes (S₁, S₂, . . . , S₁₁). As shown in FIG. 7B, first, a node S1 is selected from the graph reflecting domain knowledge because of its centrality and high quality. The centrality means that a highly ranked item is representative of a local group in the set. Then, the node S₁ decreases quality of similar nodes. The DRHQA model picks up next node S₂, which is the least similar to S₁, with consideration of quality. The whole process is repeated until no nodes in the graph are reached.

Returning to FIG. 4A, the extracted top K high quality salient aspects are outputted as ISR (S414).

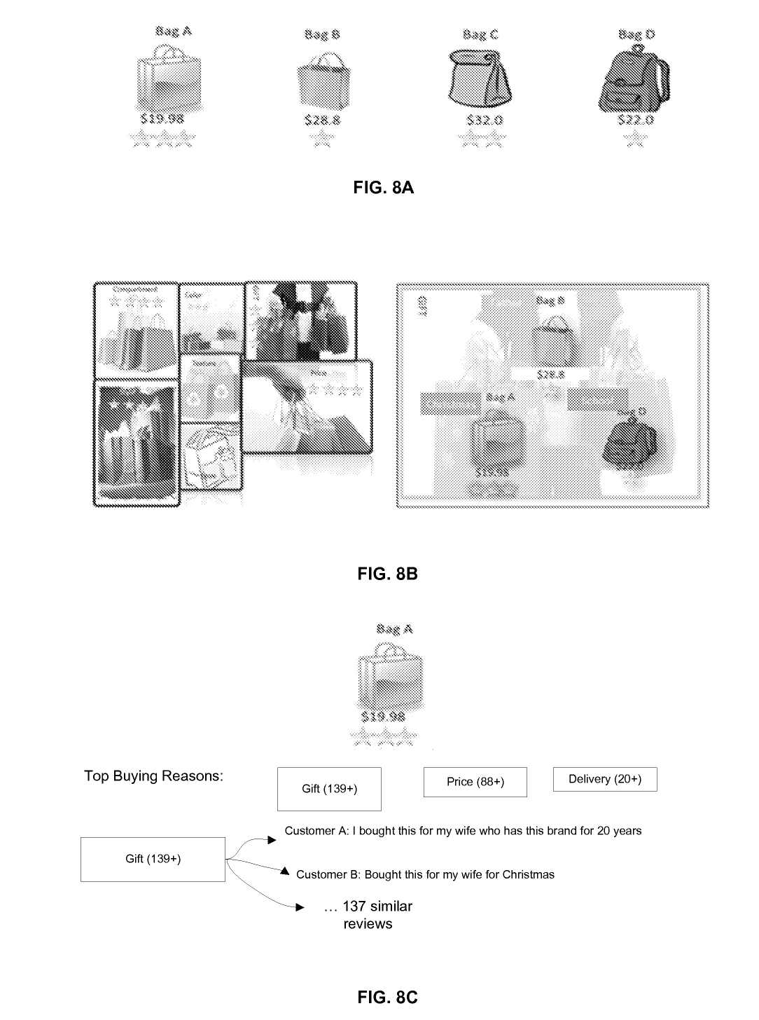

FIG. 8A illustrates an example of the current recommendation system. Assuming the customer is reviewing a bag. The system merely recommends a list of bags (Bag A, Bag B, Bag C, Bag D) with an un-explained rank information (i.e., number of stars). Although it decreases search efforts, it does not influence the customer to make a buying decision, especially for new customers or first purchase of an item. In other words, the recommendation reasons are not explicit, among other things.

FIG. 8B illustrates an exemplary recommendation in an exemplary enhanced recommender system with ISR. Suppose a customer is reviewing a bag and he/she wants to buy a gift for his/her parents. But the customer has no idea what to buy. The enhanced recommender system may display enhanced recommendation information to the customer. For example, as shown in the left figure of FIG. 8B, recommended category or characteristics of the item (e.g., bags) are displayed on a shopping website, such as “Compartment,” “Style,” “Color,” “Texture,” “Gift,” and “Price,” etc. That is, instead of a list of products, corresponding metadata with ISR are displayed first to assist the customer to navigate what item to purchase.

After the customer browses the recommendation information on this shopping website, the customer might be interested in the category of “gift”. By digging into the hierarchical category of “gift”, i.e., by clicking the displayed category “Gift,” the customer is recommended with items in the “Gift” category, with ISR. For example, as shown in the right figure of FIG. 8B, the customer is recommended with Bag B for Father, Bag A for Christmas, and Bag D for School, etc. Thus, the customer is able to find the item that has a good social reputation as a gift.

Further, the customer may click the gift feature of that a particular recommended item, as shown in FIG. 8C. When the customer clicks on the Bag A, the recommender system further displays top buying reasons for that item, with respect to certain aspects such as Gift, Price, and Delivery, etc., based on ISR. Each aspect may show reviews as social supports for that ISR, such as Customer A bought this item for his wife for Christmas, Customer B also bought this item for his wife for Christmas, and so on. The total available reviews may also be indicated together with the corresponding aspect. Other display methods may also be used.

According to disclosed embodiments, enhanced visualization may be provided. Visualization may be desired for ISR. From Bayesian view, the event that one reason is recommended to new customers has probability and utility. Therefore, different with other visualization applied in online retailers, it is better to show reasons size based on their probability other than list them evenly. For example, if a customer comes to buy a bag for his girlfriend, the customer can click “gift” cluster to find desired bags, which is infeasible to do on most of current shopping websites. Even if a new customer does not know what to buy, the customer can click clusters he/she thinks more interests to find desired items.

By using the disclosed systems and methods, ISR from online social media can be automatically extracted. A visualized solution incorporates ISR into current recommendation systems. Furthermore, the probabilistic framework to generate ISR is a generative model. The disclosed systems and methods are suitable for big data in practical application. ISR defined in the disclosed systems and methods may be also extended to other domains, such as semantic information retrieval and domain question answering systems. Other applications, advantages, alternations, modifications, or equivalents to the disclosed embodiments are obvious to those skilled in the art.

What is claimed is:

1. An enhanced recommender method, comprising:
discovering customer features from customer behavior and customer profile;
generating an initial recommender list based on the customer features and items information;
generating item social reputation (ISR) for the customer behavior and the customer profile from an online review repository; and
generating final recommendation results based on the initial recommender list and the item social reputation.

2. The method according to claim 1, further including:
displaying the final recommendation results to a user containing new customer recommendation information having item recommendation categories, recommended items with ISR, and social reviews including reasons for purchase.

3. The method according to claim 2, wherein generating item social reputation (ISR) from online review repository further including:
pre-processing online user reviews;
generating positive aspects;
selecting top K aspects; and
outputting the top K aspects as ISR.

4. The method according to claim 3, wherein pre-processing online user reviews further including:
collecting the online user reviews from a significant number of related websites instead of from a single store or website;
storing the online user reviews in an online reviews repository; and
generating chunks and constrains of the online user reviews.

5. The method according to claim 4, wherein generating chunks and constrains further including:
splitting a sentence, wherein, when the sentence does not contain any defined transition word or phrase, the sentence is used as a chunk and, when the sentence contains a transition word or phrase, the sentence is split into two sentences;
repeating the splitting until the sentence is separated as a plurality of chunks not containing any transition word or phrase; and
generating constrains based on transition words or phrases used in the splitting.

6. The method according to claim 5, wherein generating constrains based on the transition word or phrase further including:
adding either of a must-link and a cannot-link when there is the transition word or phrase between two consecutive chunks;
building the cannot-link when the transition word or phrase belongs to a category of opposition, limitation, or contradiction; and
building the must-link when the transition word or phrase does not belong to the category of opposition, limitation, or contradiction.

7. The method according to claim 3, wherein generating positive aspects further including:
generating the positive aspects by using an Aspect and Sentiment Aggregation Model with Term Weighting Schemes (ASAMTWS) algorithm.

8. The method according to claim 3, wherein selecting top K aspects further including:
selecting the top K aspects by using a Diversity in Ranking High Quality Aspect (DRHQA) model.

9. The method according to claim 7, wherein:
provided that p(wᵢ) is sentiment distribution of the set of words w={w₁, w₂, . . . wₙ}; ε indicates a dump value that controls influence of dictionary; sᵢ is a sentiment for a chunk i; and q (sⱼ=k) indicates impact from linked chunks' sentiments, importance of sentiment j and aspect k of the chunk i is defined by:
$$q ( {s}_{i} = j ) = \frac{p ( {w}_{i} + ɛ ) q ( {s}_{j} = k )}{Normalization Value}$$

10. The method according to claim 7, wherein:
a weighting term is based on frequency and reviews' quality; and
for words w being assigned sentiment j and aspect k, its weighting term M_{jkw}^{STW} is defined by:
$${M}_{jkw}^{STW} = - {log}_{2} \frac{Number of the word in review j}{Total number of the word in the dataset} ( \frac{postive voting in review j}{Total voting of the review j} + 1 ) {C}_{jkw}^{STW}$$
where S is a total number of sentiments; T is a total number of aspects; W is a total number of words; and C_{jkw}^{STW} indicates a total number of words that are assigned sentiment j and aspect k.

11. An enhanced recommender system, comprising:
a customer information extraction module configured to discover customer Item features from customer behavior and customer profile;
an item recommender module configured to generate an initial recommender list on the customer features and items information;
an Item Social Reputation (ISR) module configured to generate item social reputation for the customer behavior and the customer profile from an online review repository; and
a recommendation generation module configured to generate final recommendation results based on the initial recommender list and the item social reputation.

12. The system according to claim 11, wherein the recommendation generation module is further configured to:
display the final recommendation results to a user containing new customer recommendation information having item recommendation categories, recommended items with ISR, and social reviews including reasons for purchase.

13. The system according to claim 12, wherein the Item Social Reputation (ISR) module is further configured to:
pre-process online user reviews;
generate positive aspects;
select top K aspects; and
output the top K aspects as ISR.

14. The system according to claim 13, wherein, to pre-process the online user reviews, the ISR module is further configured to:
collect the online user reviews from a significant number of related websites instead of from a single store or website;
store the online user reviews in online reviews repository; and
generate chunks and constrains of the online user reviews.

15. The system according to claim 14, wherein, to generate the chunks and constrains, the ISR module is further configured to:
split a sentence, wherein, when the sentence does not contain any defined transition word or phrase, the sentence is used as a chunk and, when the sentence contains a transition word or phrase, the sentence is split into two sentences;
repeat the splitting until the sentence is separated as a plurality of chunks not containing any transition word or phrase; and;
generate constrains based on transition words or phrases used in the splitting.

16. The system according to claim 15, wherein, to generate constrains based on the transition word or phrase, the ISR module is further configured to:
add either of a must-link and a cannot-link when there is the transition word or phrase between two consecutive chunks;
build the cannot-link when the transition word or phrase belongs to a category of opposition, limitation, or contradiction; and
build the must-link when the transition word or phrase does not belong to the category of opposition, limitation, or contradiction.

17. The system according to claim 13, wherein, to generate positive aspects, the ISR module is further configured to:
generate the positive aspects by using an Aspect and Sentiment Aggregation Model with Term Weighting Schemes (ASAMTWS) algorithm.

18. The system according to claim 13, wherein, to select top K aspects, the ISR module is further configured to:
select the top K aspects by using a Diversity in Ranking High Quality Aspect (DRHQA) model.

19. The system according to claim 17, wherein:
provided that p(wᵢ) is sentiment distribution of the set of words w={w₁, w₂, . . . wₙ}; ε indicates a dump value that controls influence of dictionary; sᵢ is a sentiment for a chunk i; and q (sⱼ=k) indicates impact from linked chunks' sentiments, importance of sentiment j and aspect k of the chunk i is defined by:
$$q ( {s}_{i} = j ) = \frac{p ( {w}_{i} + ɛ ) q ( {s}_{j} = k )}{Normalization Value}$$

20. The system according to claim 17, wherein:
a weighting term is based on frequency and reviews' quality; and
for words w being assigned sentiment j and aspect k, its weighting term M_{jkw}^{STW} is defined by:
$${M}_{jkw}^{STW} = - {log}_{2} \frac{Number of the word in review j}{Total number of the word in the dataset} ( \frac{postive voting in review j}{Total voting of the review j} + 1 ) {C}_{jkw}^{STW}$$
where S is a total number of sentiments; T is a total number of aspects; W is a total number of words; and C_{jkw}^{STW} indicates a total number of words that are assigned sentiment j and aspect k.
